(19) United States
(12) Patent Application Publication
(10) Pub. No.: US 2026/0007566 A1
(43) Pub. Date: Jan. 8, 2026

(54) METHOD FOR ADAPTING MASSAGE SEQUENCES TO DIFFERENT TYPES OF SEATS

(71) Applicant: Conti Temic microelectronic GmbH, Ingolstadt (DE)

(72) Inventors: Michael Beuschel, Stammham (DE); Stefan Bauer, Engelbrechtsmünster (DE)

(73) Assignee: Conti Temic microelectronic GmbH, Ingolstadt (DE)

(21) Appl. No.: 19/258,069

(22) Filed: Jul. 2, 2025

(30) Foreign Application Priority Data
Jul. 3, 2024 (DE) 10 2024 206 240.5

(51) Int. Cl. A61H 9/00; A61G 15/00; A61G 15/12

(52) U.S. Cl. CPC A61H 9/0078; A61G 15/007; A61G 15/12; A61H 2201/0149; A61H 2201/5007; A61H 2201/5056

(57) ABSTRACT

A method for adapting massage sequences to different types of seats, which have a number of inflatable cushions arranged at specified locations in the seat, is described. A calculation model is parameterized for a particular seat type, and target values for each step of a massage sequence are read in by a control unit and control commands for valves are output depending on the degree of filling estimated by the calculation model during the massage sequence, wherein the target values of a step comprise at least the duration of a control command and the desired degree of filling of a cushion. The duration of a control command for filling a cushion is shortened, if necessary, in relation to the target value for each step of a massage sequence, in such a way that a specified degree of filling is not exceeded.

### CROSS-REFERENCE TO RELATED APPLICATIONS

This application claims priority to German patent application No. 10 2024 206 240.5, filed Jul. 3, 2024, which is hereby incorporated by reference.

### TECHNICAL FIELD

The technical field relates generally to filling elastic cushions of seats with a fluid to achieve a massage function.

### BACKGROUND

In transportation, fillable elastic cushions are increasingly being used to shape seat contours. These permit an individual adaptation of the seats to the occupants. For this purpose, the elastic cushions are usually filled with air. However, any other fluid or gas is also possible. Originally found in high-priced transportation means, this equipment is now entering the middle and lower price segments.

If such air cushions, which can be filled with compressors via controllable valves, are present, alternating filling and emptying processes can also be controlled in order to implement massage functions. Pneumatic massage functions usually use a plurality of pneumatic air cushions in the seat back, which are filled and emptied in a cyclical manner to represent a dynamic force effect similar to a manual massage. The intention here is to achieve pre-specified pressure sequences in the individual air cushions. Currently, the control usually takes place in a purely time-based manner, i.e. without feedback from a pressure sensor. If a new massage sequence is created, an existing massage sequence is intended to be ported to a different seat, or if the components used are changed (e.g., a compressor with a different power or valves with a different cross section), the control times must be redetermined experimentally in each case.

DE 10 2010 063 136 B4 describes a pneumatic system in which the vessel pressure is determined by means of a mathematical model.

DE 10 2011 122 392 A1 describes a pressure model based on characteristic curves. The effect of all of the components of a system for filling, holding and emptying air is represented in a single characteristic curve. This means that it is not possible to assign individual components, nor is it possible to carry out a partial parametrization when changes are made to a part of the system.

DE 10 2018 209 386 B3 also describes a pressure model, which uses a simplified calculation of the physical behavior of the pneumatic components.

DE 20 2020 105 243 U1 describes a massage system in which the sequence control is executed on a central vehicle computer and can also receive updates from an external server.

The disadvantage of the last-mentioned massage system is that the temporal sequence of the massage control commands must be adapted exactly to the seat type installed in the vehicle. Otherwise, different built-in pneumatic components (compressor, valves, hose lines, air cushions, etc.) as well as seating characteristics (e.g. upholstery, cover, seams) would lead to a different massaging effect and, under certain circumstances, also to overloading of components.

In addition, in future, massage sequences are expected to be booked as a service, for example, or created by end customers themselves and exchanged with other end customers. All of this increases the number of massage sequences available and consequently the (usually experimental) effort required to adapt each individual massage sequence to each possible seat type.

As such, it is desirable to provide a method for a simplified adaptation of massage sequences to different types of seats.

### SUMMARY

The disclosure provides a method for adapting massage sequences to different types of seats, which have a number of inflatable cushions arranged at specified locations in the seat, wherein each cushion is connected via a controllable valve assigned thereto to a compressor for filling with a fluid and to the environment for emptying, wherein each valve is connected to a control unit, which is designed to control the valve by means of control signals in such a way that an assigned cushion is fluidically connected via the valve to the compressor for filling or to the environment for emptying, having a parametrizable calculation model, which can determine the properties of the inflatable cushions at least with regard to the time within which a specified degree of filling is reached, depending on at least their location in the vehicle seat, the power of the compressor and their size, in order to then continuously determine the degree of filling of a cushion, wherein the calculation model is connected to the control unit to receive the control signals for the valves as input variables and to provide a signal that represents the degree of filling of a cushion to the control unit, wherein the control unit determines the control signals for a valve depending on the signal for the degree of filling of the assigned cushion determined by the calculation model, wherein at least the following steps are carried out:
parametrizing the calculation model for a specific seat type,
reading in the target values of each step of a massage sequence by the control unit and outputting the control commands depending on the degree of filling estimated by the calculation model during the massage sequence, wherein the target values of a step comprise at least the duration of a control command and the desired degree of filling of a cushion,
shortening the duration of a control command for filling a cushion, if necessary, in relation to the target value for each step of a massage sequence, in such a way that a specified degree of filling is not exceeded.

A massage sequence consists of steps, which in turn contain at least a duration and an intensity (e.g., pressure to be achieved in a cushion). Holding phases and pauses can also be specified. Optionally, a region or position of a cushion in a seat can also be included for each step.

All seats of a particular type use the same components as cushions, compressors, valves, fluid lines, etc. for all components involved in the massage.

The calculation model is parameterized for the respective seat type. This model continuously estimates the degree of filling of the individual massage air chambers or cushions depending on control conditions and optionally on environmental and usage conditions. The calculation model is designed in such a way that it provides sufficiently accurate values even with a wide variety of seating loads (e.g. body sizes).

The target values of each step of the massage sequence are read in by the control unit and the control commands are output to the valves for filling and emptying a cushion depending on the degree of filling estimated by the calculation model, so that the target values are achieved as best as possible.

The calculation is performed continuously during the execution of a massage sequence. In this case, according to the invention, the duration of the control commands for filling for each step is shortened, if necessary, in such a way that a specified degree of filling is simply not exceeded.

In a design of the method, the calculation model continuously estimates the degree of filling of the individual massage air chambers also depending on environmental and usage conditions, as a result of which a higher degree of accuracy can be achieved.

In a design of the method, in the event that in a step the degree of filling is reached in a time period earlier than specified, a beginning of a subsequent step, which is intended to start at the time at which the degree of filling is reached, is also started earlier.

This means that an air cushion may start to be filled earlier if a previous filling of a cushion is carried out more quickly, so that the compressor can run without interruption.

In a development, this earlier start can only take place if the time period is smaller than a specified value.

In a further design or development, in the event that in a step the degree of filling is reached earlier than specified, and the subsequent step is only intended to begin after a pause, the pause can be extended to the specified start of the subsequent step.

The reaching of the degree of filling can be followed by a holding phase lasting up to the specified time at which the specified degree of filling is reached.

In a yet further design or development, in the event that in a step the degree of filling is reached in a time period later than specified, a beginning of a subsequent step, which is intended to start at the time at which the degree of filling is reached, can also be started later.

In a design of the method, in the event that fewer cushions are present in a seat type than are provided in a massage sequence, massage steps can be applied to the nearest adjacent cushions.

### BRIEF DESCRIPTION OF THE FIGURES

The disclosure is described in more detail below with reference to exemplary embodiments with the aid of figures, in which

FIG. 1 shows a schematic representation of a (vehicle) seat with components required for a massage function,

FIG. 2 shows a simple massage sequence according to specified target durations and target degrees of filling,

FIG. 3 shows a simple massage sequence with filling and emptying durations adapted to a different seat type by means of a calculation model and

FIG. 4 shows an application for transmitting massage sequences to different types of seats.

### DETAILED DESCRIPTION

Exemplary implementations are described hereafter. When reference is made here to the degree of filling of an air cushion, the pressure or alternatively the volume, the mass of the air in the air cushion or the geometric stroke of the air cushion is also meant.

When the term positioning speed is used, this means, for example, a pressure gradient, a compressor speed/voltage/power, a volume or mass flow as well as an adjustable preliminary pressure.

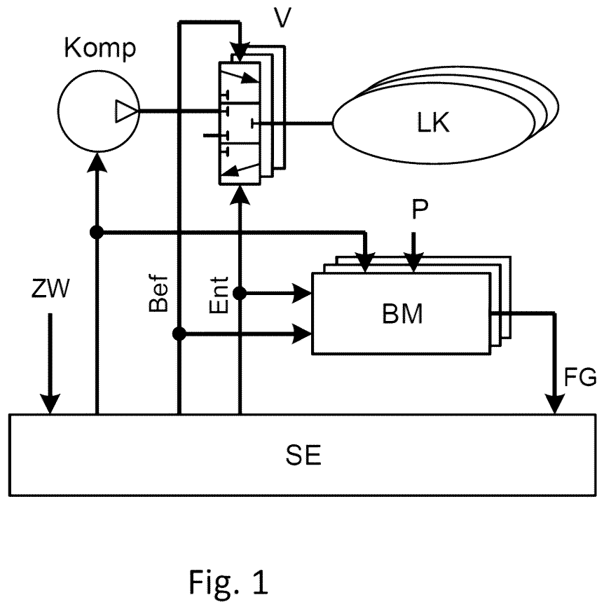

FIG. 1 shows the schematic diagram of a vehicle seat with a compressor Komp, which can pump air into air cushions LK assigned to it via valves V. When air is mentioned here, this can also be or refer to any gas or other fluid. The valves V are controlled by a control unit SE with control commands Bef, Ent, by means of which one of, optionally, a plurality of valves V can receive a filling command Bef for connecting an air cushion LK assigned to it to the compressor Komp via the valve V, or an emptying command Ent for connecting an air cushion LK to the environment via the assigned valve V. The control commands represent the commands actually executed.

The vehicle seat has a calculation model BM for the degree of filling FG of usually a plurality of air cushions LK, which can estimate the degree of filling FG at least from the valve control times, which are determined from the control commands Bef, Ent, and seat parameters P, as well as from the power of the compressor KOMP. A single parameter set P is determined in advance for each seat type, which can then be used in all seats of the same seat type and is input into the calculation model BM. The calculation model BM can also be part of the control unit SE and, in particular, be implemented by a program for execution in a processor. A neural network or artificial intelligence can also be used.

The control unit SE can specify the target values for the pressure in the cushion and/or the times for filling and emptying, so that the control commands Bef, Ent can also be executed accordingly depending on the degree of filling FG determined by the calculation model BM.

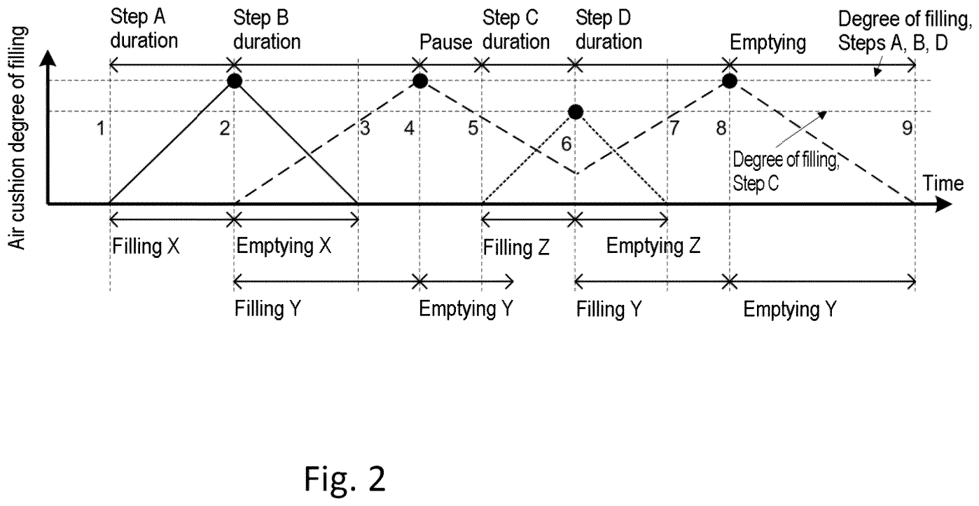

FIG. 2 shows an example of a short massage sequence with 4 steps, wherein for each step a (target) duration and a (target) degree of filling is defined. In addition, pauses can also be introduced. Different values can be specified for each step and each air cushion LK, depending on the typical or expected behavior of the seat, the air cushion LK, the valves V and the air supply (compressor KOMP) and depending on the desired massage effect.

The individual steps are as follows:
Step A: At time (1), air cushion X should begin filling.
Step B: As soon as air cushion X has reached the target degree of filling (time 2), it begins to empty due to activation by the control unit SE (up to time 3). At the same time, air cushion Y starts filling so that the compressor KOMP can run without interruption.
Pause: As soon as air cushion Y has reached the target degree of filling (time 4), it begins to empty due to activation by the control unit SE. A pause is inserted until the next step, during which e.g. the compressor KOMP is at rest (times 4 to 5).
Step C: Air cushion Z is filled to a lower specified target degree of filling (times 5 to 6).
Step D: A refilling of air cushion Y begins immediately afterward (time 6). At this time, it is not yet fully emptied. The time period (6 to 8) is therefore specified to be shorter than in step B (times 2 to 4).

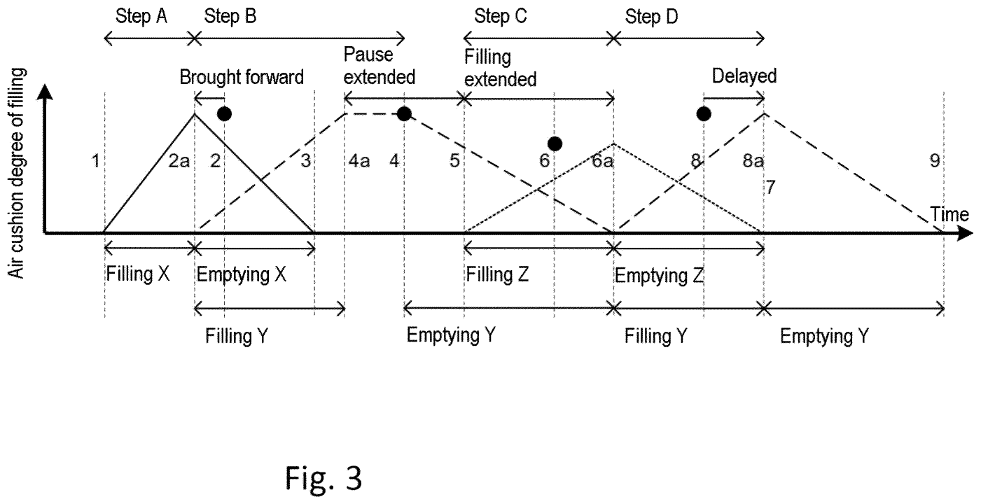

In FIG. 3, an example is now shown describing, for another seat type and thus for other values (parameters) for the valve and air line cross sections, compressor power, etc., how the degrees of filling estimated with a calculation model BM affect the control commands derived therefrom by the control unit SE:
Step A: Air cushion X is filled faster than specified. This brings the end of the filling process forward from time (2) to time (2a).
Step B: In order to avoid an excessively short pause (from time 2a to time 2) for the compressor KOMP, the beginning of step B is also brought forward to time (2a). Air cushion Y also fills faster than specified (up to time 4a).
Pause: The pause is extended (from time 4a to time 5) in order to be in sync again with the specified time at time (5).
Step C: Air cushion Z fills more slowly than specified. This delays the end of the filling process from time (6) to time (6a).
Step D: Accordingly, air cushion Y can only be refilled from time (6a). The calculation model BM takes into account that air cushion Y is already fully emptied at this point. This shifts the time at which the target degree of filling is reached from time (8) to time (8a) (despite faster filling).

The filling and emptying sequences of air cushions X, Y, Z shown in FIG. 3 based on control commands for the valves V assigned to the air cushions X, Y, Z show a possible behavior of the method in online operation. In this case, it is possible to react to deviations of the seat type from the specified target values retrospectively—after the calculation of the degree of filling FG by the calculation model BM—by, for example, shifting times.

Using the above-mentioned method, massage programs can be freely exchanged between seats that have the same number of air cushions and a similar arrangement.

Via an optional region or position specification (e.g. via uniform coordinates within the seat) for each step, massage programs can additionally also be executed on seats with a different number or arrangement of air cushions. All steps are assigned here to the air cushions located closest to their position. It is also possible to skip steps for non-existent positions.

For example, a wave-like massage sequence (i.e. air cushions are filled in the vertical direction one after the other) can therefore be adapted to the actual number of air cushions. If 6 air cushions (numbers 1 to 6) are specified in such a massage sequence, but the seat has only 4 air cushions, the following assignment can be made, for example:
Air cushion specification 1→air cushion 1 in the seat
Air cushion specification 2→air cushion 2 in the seat
Air cushion specification 3→skip
Air cushion specification 4→air cushion 3 in the seat
Air cushion specification 5→skip
Air cushion specification 6→air cushion 4 in the seat

It is possible to choose to keep the (average) duration of each step or the total duration of the sequence.

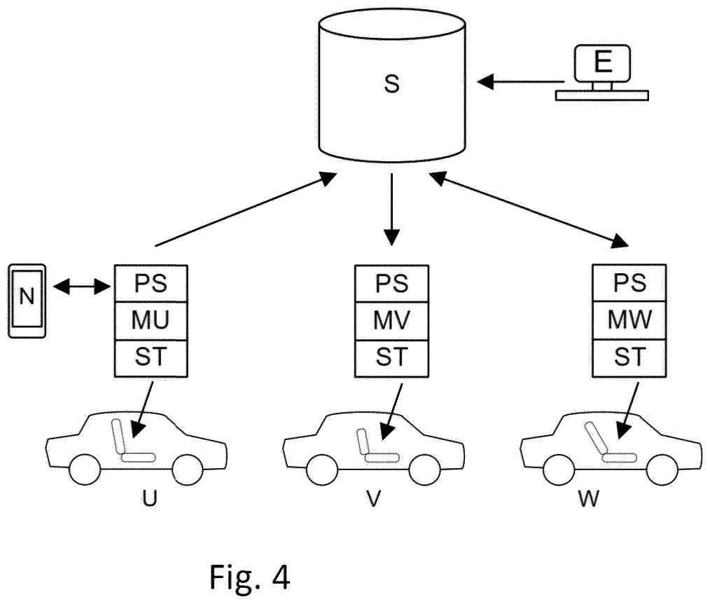

FIG. 4 shows an example of a possible application of the method for different use cases. An external memory (or server) S in the form of a database is connected to a plurality of vehicles, in which seats of different types U, V, W are installed. The database S stores universally applicable massage programs.

For each seat U, V, W or each vehicle there is a program memory PS for storing one or more universally applicable massage programs. In addition, each vehicle has a calculation model MU, MV, MW, which is parameterized for the respective seat type U, V, W. Finally, a controller ST executes the resulting control commands on the respective seat.

Different usage scenarios are described below:
The user N of the vehicle with seat type U creates or edits their own massage program in their program memory PS and uploads it to the server S. On the individual seat, the massage program is adapted to the seat type U by the calculation model MU and is executed by the controller ST.
The user of the vehicle with seat type V downloads massage programs from the server S to their program memory PS (e.g. the same one created by user N). On the individual seat, the massage program is adapted to the seat type V by the calculation model MV and is executed by the controller ST.
The user of the vehicle with seat type W downloads massage programs from the server S as well as uploads them to the server S. On the individual seat, the massage program is adapted to the seat type W by the calculation model MW and is executed by the controller ST.
The vehicle manufacturer E (or else a fleet operator or service provider) creates additional universal massage programs and stores them on the server S so that users of different vehicles can download them to their program memory PS.

The method described above has the advantage of an improved interchangeability of massage programs between seats of different types and enables new configuration options for end customers, for their vehicles, through individually selected massage programs.

It is no longer necessary to adjust the massage programs to the seat types used (or to the vehicle/seat manufacturer). This significantly reduces the development effort for new massage programs.

This protects the pneumatic components against overloading in the case of user-defined massage programs or those created by third parties.

1. A method for adapting massage sequences to different types of seats, which have a number of inflatable cushions arranged at specified locations in the seat, wherein each cushion is connected via a controllable valve assigned thereto to a compressor for filling with a fluid and to the environment for emptying,
wherein each valve is connected to a control unit, which is designed to control the valve by means of control signals in such a way that an assigned cushion is fluidically connected via the valve to the compressor for filling or to the environment for emptying,
having a parametrizable calculation model, which can determine the properties of the inflatable cushions at least with regard to the time within which a specified degree of filling is reached, depending on at least their location in the vehicle seat, the power of the compressor and their size, in order to then continuously determine the degree of filling of a cushion, wherein the calculation model is connected to the control unit to receive the control signals for the valves as input variables and to provide a signal that represents the degree of filling of a cushion to the control unit,
wherein the control unit determines the control signals for a valve depending on the signal for the degree of filling of the assigned cushion determined by the calculation model, wherein at least the following steps are carried out:
parametrizing the calculation model for a specific seat type,
reading in the target values of each step of a massage sequence by the control unit and outputting the control commands depending on the degree of filling estimated by the calculation model during the massage sequence, wherein the target values of a step comprise at least the duration of a control command and the desired degree of filling of a cushion,
shortening the duration of a control command for filling a cushion, if necessary, in relation to the target value for each step of a massage sequence, in such a way that a specified degree of filling is not exceeded.

2. The method as claimed in claim 1, wherein the calculation model continuously estimates the degree of filling of the individual massage air chambers also depending on environmental and usage conditions.

3. The method as claimed in claim 1, wherein, in the event that in a step the degree of filling is reached in a time period earlier than specified, a beginning of a subsequent step, which is intended to start at the time at which the degree of filling is reached, is also started earlier.

4. The method as claimed in claim 3, wherein the earlier start only takes place if the time period is smaller than a specified value.

5. The method as claimed in claim 1, wherein, in the event that in a step the degree of filling is reached earlier than specified, and the subsequent step is only intended to begin after a pause, the pause is extended to the specified start of the subsequent step.

6. The method as claimed in claim 5, wherein the reaching of the degree of filling is followed by a holding phase lasting up to the specified time at which the specified degree of filling is reached.

7. The method as claimed in claim 1, wherein, in the event that in a step the degree of filling is reached in a time period later than specified, a beginning of a subsequent step, which is intended to start at the time at which the degree of filling is reached, is also started later.

8. The method as claimed in claim 1, wherein, in the event that fewer cushions are present in a seat type than are provided in a massage sequence, massage steps are applied to the nearest adjacent cushions.

9. The method as claimed in claim 1, wherein, in the event that fewer cushions are present in a seat type than are provided in a massage sequence, massage steps for excess cushions are omitted.
